(19) United States
(12) Patent Application Publication
(10) Pub. No.: US 2026/0139160 A1
(43) Pub. Date: May 21, 2026

(54) ACQUISITION AND INTEGRATION ASSEMBLY OF BATTERY MODULE WITH FLAME-RETARDANT PROPERTY AND PREPARATION METHOD THEREOF

(71) Applicant: SHENZHEN YN TECH CO., LTD., Shenzhen (CN)

(72) Inventors: Zhun Li, Shenzhen (CN); Hua Zhang, Shenzhen (CN); Yangsong Li, Shenzhen (CN); Chen Nie, Shenzhen (CN); Shengqi Huang, Shenzhen (CN); Zhichao Zeng, Shenzhen (CN)

(21) Appl. No.: 19/450,776

(22) Filed: Jan. 16, 2026

Related U.S. Application Data
(63) Continuation of application No. PCT/CN2025/095595, filed on May 17, 2025.

(30) Foreign Application Priority Data
Jul. 17, 2024 (CN) 202410961128.8

(51) Int. Cl. C09J 7/25; C09J 7/35; C09J 11/06; H01M 10/42

(52) U.S. Cl. CPC C09J 7/255; C09J 7/35; C09J 11/06; H01M 10/425; C09J 2203/33; C09J 2301/122; C09J 2301/304; C09J 2301/408; C09J 2301/414; C09J 2467/006; H01M 2010/4271

(57) ABSTRACT

The present disclosure relates to a technical field of new energy power battery pack and energy storage, and provides an acquisition and integration assembly of a battery module with flame-retardant property and a preparation method. The acquisition and integration assembly includes a PET substrate film coated with a flame-retardant adhesive layer and an acquisition circuit assembly hot-press encapsulated on one side of the flame-retardant adhesive layer of the PET substrate film; the flame-retardant adhesive layer includes following components in parts by weight: 20 to 80 parts of a thermally curable resin, 5 to 20 parts of a curing agent, and 20 to 80 parts of a flame retardant. The acquisition circuit assembly is connected with each conductive connection busbar by FPC, FFC, FDC, or FCC, and is formed by integral hot-press encapsulating and curing after being adhered and fixed with a PET base film coated with a flame-retardant adhesive layer.

### CROSS-REFERENCE TO RELATED APPLICATIONS

The present application is a continuation application of PCT application No. PCT/CN2025/095595 filed on May 17, 2025, which claims the benefit of Chinese Patent Application No. 202410961128.8 filed on Jul. 17, 2024. The contents of all of the aforementioned applications are incorporated by reference herein in their entirety.

### FIELD

The present disclosure relates to a technical field of new energy power battery pack and energy storage, in particular to an acquisition and integration assembly of a battery module with flame-retardant property and a preparation method thereof.

### BACKGROUND

An acquisition and integration busbar (e.g., CCS or IBB) is a highly integrated system for battery signal acquisition (e.g., temperature acquisition, pressure acquisition etc.) and management, existing CCS products are primarily assembled from a FPC component and conductive busbar connection aluminum strips (i.e., aluminum busbar) using specific methods, the FPC component includes a FPC board, connectors, nickel tabs, NTC thermistors, etc. All of the components are connected by welding and then assembled into a single integrated unit through hot pressing with black adhesive films, thereby enhancing reliability of the whole product.

However, due to complex operating conditions of battery packs, there is currently no mature technology in the industrial field that can completely prevent thermal runaway in a battery cell. When the battery cell experiences the thermal runaway, an explosion-proof valve of the battery cell will activate to release gas with high temperature and high pressure. The temperature of the gas often reaches more than 500° C., although the existing CCS products on the market are made from flame-retardant materials, the organic adhesive film covering the surface of the acquisition circuit (e.g., FPC) has a temperature resistance rating of only 150° C. (for PET) or 250° C. (for PI), when exposed to a high temperature like 500° C., such film may soften, liquefy, and shrink, which leads to poor fixation of the copper wires in the acquisition circuit, once these copper wires contact with each other, short-circuiting and sparking may occur, which may cause uncontrollable intense combustion of the entire battery pack and result in property damage and human safety risks.

In a patent application with a publication number of CN116505204A, the flame-retardant effect was achieved by adhering flame-retardant layers such as mica sheets, flexible ceramic thin films, mylar sheets, or fire-resistant paper onto the adhesive film layer, thereby improving stability and safety of the circuit. However, this method of adhering the flame-retardant layers adds the assembly steps for the battery pack, at the same time, the adhesion stability of the flame-retardant layers is relatively poor, and the bonding strength with the acquisition circuit components is insufficient, during the thermal runaway of the battery cell, these layers are prone to delamination, the reliability of flame retardation still requires further improvement.

### SUMMARY

In view of the above shortcomings and deficiencies in the prior art, a purpose of the present disclosure is to provide an acquisition and integration assembly of a battery module with flame-retardant property. The acquisition and integration assembly of the battery module of the present disclosure utilizes a PET substrate film coated with a flame-retardant adhesive to fix the acquisition circuit assembly, the heat-insulating and flame-retardant layer is closely fit with the acquisition circuit, which ensures that the assembly does not delaminate in the event of thermal runaway in battery cells, prevents high-temperature gas from contacting the acquisition circuit, thereby avoiding the risk of short-circuit and sparking, and stop spread of the thermal runaway.

Another purpose of the present disclosure is to provide a preparation method of an acquisition and integration assembly of a battery module with flame-retardant property.

The purpose of the present disclosure is realized through the following technical solutions:

An acquisition and integration assembly of a battery module with flame-retardant property, includes: a PET substrate film coated with a flame-retardant adhesive layer; and an acquisition circuit assembly hot-press encapsulated on one side of the flame-retardant adhesive layer of the PET substrate film; the flame-retardant adhesive layer comprises following components in parts by weight: 20-80 parts of a thermally curable resin, 5-20 parts of a curing agent, and 20-80 parts of a flame retardant.

Further, a thickness of the PET substrate film is 0.03-0.5 mm, and a thickness of the flame-retardant adhesive layer is 0.1-1 mm.

Further, the acquisition circuit assembly comprises a conductive circuit and a plurality of conductive connection busbars connected with the conductive circuit; the conductive circuit is an FPC (Flexible Printed Circuit), and the FPC is individually connected with each of the plurality of conductive connection busbars via a nickel tab; or the conductive circuit is an FFC (Flexible Flat Cable), and the FFC is individually connected with each of the plurality of conductive connection busbars via the nickel tab; or the conductive circuit is an FDC (Flexible Die cutting Circuit), and the FDC is individually connected with each of the plurality of conductive connection busbars via the nickel tab, or the FDC is directly connected with each of the plurality of conductive connection busbars; or the conductive circuit is an FCC (Flat Flexible Cable), the FCC is formed by utilizing the FFC to be individually connected with each of the plurality of conductive connection busbars via an FPC sub-board.

Further, the thermally curable resin is at least one of nitrile rubber, epoxy resin, polyester resin, acrylic resin, and polyurethane resin.

Further, the curing agent is at least one of 4,4′-diaminodiphenyl sulfone, dicyandiamide, acid anhydride, imidazole, HDI, TDI, and melamine.

Further, the flame retardant is at least one of aluminum diethylphosphonate, hexaphenoxycyclotriphosphazene, and ammonium polyphosphate.

In addition, for enhancing the flame retardant and heat insulation effect of the acquisition integrated assembly, a mica sheet, mica paper, flexible ceramic, fire-resistant paper, aerogel, or ceramic sheet flame-retardant sheet layer is additionally arranged between the PET substrate film and the acquisition circuit assembly. A flame-retardant adhesive layer is coated between the flame-retardant sheet layer and the acquisition circuit assembly, and between the flame-retardant sheet layer and the PET substrate film.

The acquisition circuit assembly is provided with or without an opening at a location corresponding to a battery cell explosion-proof valve; when the opening is provided, a flame-retardant adhesive layer is or is not provided on a side of the acquisition circuit assembly facing a battery cell; when no opening is provided, the flame-retardant adhesive layer is provided on the side of the acquisition circuit assembly facing the battery cell.

The conventional structures not recited in the present disclosure can refer to the patent application with the publication number of CN116505204A.

A preparation method of preparing an acquisition and integration assembly of a battery module with flame-retardant property, includes following preparation steps:
(1) adding terephthalic acid, ethyl isocyanatoacrylate, and an organotin catalyst to an ethyl acetate solvent, heating and stirring to react, and obtaining a crosslinking monomer solution;
(2) mixing the crosslinking monomer solution obtained in step (1) with an acrylic acid monomer and an acrylate monomer, diluting with the ethyl acetate solvent, removing oxygen with nitrogen, adding an initiator, heating to undergo copolymerization reaction, and obtaining a modified acrylic resin solution;
(3) mixing the modified acrylic resin solution obtained in step (2) with an epoxy resin, heating to react, cooling to room temperature, adding a flame retardant and a curing agent, and mixing uniformly to obtain a mixed adhesive solution;
(4) coating the mixed adhesive solution obtained in step (3) onto a PET substrate film, attaching and fixing the acquisition circuit assembly, integral hot-press encapsulating and curing the PET substrate film and the acquisition circuit assembly, and obtaining the acquisition and integration assembly of the battery module with flame-retardant property.

Further, in step (1), a molar ratio of the terephthalic acid to the ethyl isocyanatoacrylate is 1:2; the organotin catalyst is dibutyltin dilaurate; and a temperature range for heating and stirring to react is 60 to 90° C.

Further, in step (2), the acrylic acid monomer is one or a mixture of acrylic acid and methacrylic acid; and the acrylate monomer is at least one of methyl acrylate, methyl methacrylate, ethyl acrylate, ethyl methacrylate, hydroxyethyl acrylate, hydroxyethyl methacrylate, hydroxypropyl methacrylate, hydroxybutyl methacrylate, butyl acrylate, butyl methacrylate, 2-ethylhexyl acrylate, and 2-ethylhexyl methacrylate.

Further, in step (2), a mass ratio of the crosslinking monomer contained in the crosslinking monomer solution to the acrylic acid monomer and the acrylate monomer is 0.05 to 0.3:1 to 2:1 to 2.

Further, in step (2), an amount of the ethyl acetate solvent added for dilution results in a solid content of a reaction system of 30% to 50%; the initiator is azobisisobutyronitrile or azobisisovaleronitrile; and a temperature range for the copolymerization reaction is 60 to 80° C.

Further, in step (3), the epoxy resin is a bisphenol A epoxy resin or a bisphenol F epoxy resin; and a mass ratio of the modified acrylic resin contained in the modified acrylic resin solution to the epoxy resin is 2 to 4:1 to 2.

Further, in step (3), a temperature range for a heating reaction is 40 to 60° C., a duration range for the heating reaction is 0.5 to 3 hours.

Further, in step (4), the mixed adhesive solution is coated onto the PET substrate film using a roll-to-roll process.

Compared to the prior art, the beneficial effects of the present disclosure are as follows:
(1) The present disclosure utilizes a specific flame-retardant adhesive layer to achieve thermal insulation and flame retardancy for the acquisition circuit assembly, compared with conventional high-temperature resistant and insulating flame-retardant sheet layers, the flame-retardant adhesive layer exhibits strong bonding properties with the acquisition circuit assembly, the heat-insulating and flame-retardant layer is closely fit with the acquisition circuit, which ensures that the assembly does not delaminate in the event of thermal runaway of the battery cells, and prevents high-temperature gas from contacting the acquisition circuit, thereby avoiding the risk of short-circuit and sparking, and stop spread of the thermal runaway.
(2) The PET substrate film coated with the flame-retardant adhesive layer used in the present disclosure enables roll-to-roll production and preparation, compared with the technical solution involving the lamination of conventional high-temperature resistant and insulating flame-retardant sheet layers, the present disclosure has advantages such as higher reliability, greater production efficiency, and lower cost.
(3) The present disclosure further utilizes a thermally curable resin system including modified acrylic resin and epoxy resin, which provides excellent thermal curing performance and bonding effect; by utilizing a crosslinking monomer obtained from the reaction of terephthalic acid and ethyl isocyanatoacrylate, to copolymerize and crosslink-modify the acrylic resin, the cohesive strength of the resin is increased, on the other hand, the bonding force with the PET substrate film is improved, the adhesive strength between the flame-retardant adhesive layer and both the PET substrate film and the acquisition circuit assembly is increased, which realizes the adhesive bonding and hot-press encapsulation of the acquisition circuit assembly even under high flame-retardant additive loading conditions, and increase the structural stability and flame-retardant performance of the hot-pressed acquisition circuit assembly.

### DETAILED DESCRIPTION

The present disclosure is described in further detail below with reference to specific embodiments, however, the embodiments of the present disclosure are not limited to those described herein.

### Embodiment 1

An acquisition and integration assembly of a battery module with flame-retardant property includes a PET substrate film coated with a flame-retardant adhesive layer and an acquisition circuit assembly hot-press encapsulated on one side of the flame-retardant adhesive layer of the PET substrate film. The acquisition and integration assembly of the battery module with flame-retardant property is prepared by the following method:

A flame-retardant adhesive is coated onto a PET substrate film with a thickness of 0.2 mm, the coating thickness of the flame-retardant adhesive is 0.5 mm, subsequently, the acquisition circuit assembly is attached and fixed on the PET substrate, followed by integral hot-press encapsulating and curing the PET substrate and the acquisition circuit assembly, the acquisition and integration assembly of the battery module with flame-retardant property is obtained. The acquisition circuit assembly includes an FPC conductive circuit and a number of conductive connection busbars, the FPC conductive circuit is individually connected with each conductive connection busbar via nickel tab transition.

The flame-retardant adhesive includes 60 parts (in terms of solid content) of bisphenol A epoxy resin (E-44), 10 parts of curing agent 4,4′-diaminodiphenyl sulfone, and 60 parts of flame retardant aluminum diethylphosphonate. A preparation method of the flame-retardant adhesive is as follows: each raw material is weighed according to the specified parts by weight, and the bisphenol A epoxy resin, the curing agent 4,4′-diaminodiphenyl sulfone, and the flame retardant aluminum diethylphosphinate are stirred and mixed uniformly, to obtain the flame-retardant adhesive.

### Embodiment 2

An acquisition and integration assembly of a battery module with flame-retardant property includes a PET substrate film coated with a flame-retardant adhesive layer and an acquisition circuit assembly hot-press encapsulated on one side of the flame-retardant adhesive layer of the PET substrate film. The acquisition and integration assembly of the battery module with flame-retardant property is prepared by the following method:

A flame-retardant adhesive is coated onto a PET substrate film with a thickness of 0.3 mm, the coating thickness of the flame-retardant adhesive is 0.6 mm, subsequently, the acquisition circuit assembly is attached and fixed on the PET substrate, followed by integral hot-press encapsulating and curing the PET substrate and the acquisition circuit assembly, the acquisition and integration assembly of the battery module with flame-retardant property is obtained. The acquisition circuit assembly includes an FPC conductive circuit and a number of conductive connection busbars, the FPC conductive circuit is individually connected with each conductive connection busbar via nickel tab transition.

The flame-retardant adhesive includes 40 parts (in terms of solid content) of thermosetting acrylic resin (DC260B, solvent butyl acetate, solid content 60%), 20 parts (in terms of solid content) of bisphenol A epoxy resin (E-44), 10 parts of curing agent 4,4′-diaminodiphenyl sulfone, and 60 parts of flame retardant aluminum diethylphosphonate. A preparation method of the flame-retardant adhesive is as follows: each raw material is weighed according to the specified parts by weight, and thermosetting acrylic resin, the bisphenol A epoxy resin, the curing agent 4,4′-diaminodiphenyl sulfone, and the flame retardant aluminum diethylphosphinate are stirred and mixed uniformly, to obtain the flame-retardant adhesive.

### Embodiment 3

An acquisition and integration assembly of a battery module with flame-retardant property includes a PET substrate film coated with a flame-retardant adhesive layer and an acquisition circuit assembly hot-press encapsulated on one side of the flame-retardant adhesive layer of the PET substrate film. The acquisition and integration assembly of the battery module with flame-retardant property is prepared by the following method:

A flame-retardant adhesive is coated onto a PET substrate film with a thickness of 0.4 mm, the coating thickness of the flame-retardant adhesive is 0.7 mm, subsequently, the acquisition circuit assembly is attached and fixed on the PET substrate, followed by integral hot-press encapsulating and curing the PET substrate and the acquisition circuit assembly, the acquisition and integration assembly of the battery module with flame-retardant property is obtained. The acquisition circuit assembly includes an FPC conductive circuit and a number of conductive connection busbars, the FPC conductive circuit is individually connected with each conductive connection busbar via nickel tab transition.

The flame-retardant adhesive includes 40 parts (in terms of solid content) of acrylic resin, 20 parts (in terms of solid content) of bisphenol A epoxy resin (E-44), 10 parts of curing agent 4,4′-diaminodiphenyl sulfone, and 60 parts of flame retardant aluminum diethylphosphonate. A preparation method of the flame-retardant adhesive is as follows:
(1) Methyl methacrylate and butyl acrylate are mixed at a mass ratio of 1:2, then diluted with an ethyl acetate solvent to a solid content of 40%, after oxygen removal with nitrogen, the initiator azo diisobutyronitrile is added, the mixture is heated to 75° C., and undergo copolymerization for 4 hours, an acrylic resin solution is obtained.
(2) The acrylic resin solution obtained in step (1) (40 parts in terms of solid content) is mixed with bisphenol A epoxy resin (E-44, 20 parts in terms of solid content), the mixture is heated to 50° C. and reacted for 1 hour, then cooled to room temperature, subsequently, 60 parts of the flame retardant aluminum diethylphosphinate and 10 parts of the curing agent 4,4′-diaminodiphenyl sulfone are added and mixed uniformly, to obtain the flame-retardant adhesive.

### Embodiment 4

An acquisition and integration assembly of a battery module with flame-retardant property includes a PET substrate film coated with a flame-retardant adhesive layer and an acquisition circuit assembly hot-press encapsulated on one side of the flame-retardant adhesive layer of the PET substrate film. The acquisition and integration assembly of the battery module with flame-retardant property is prepared by the following method:

A flame-retardant adhesive is coated onto a PET substrate film with a thickness of 0.5 mm, the coating thickness of the flame-retardant adhesive is 0.8 mm, subsequently, the acquisition circuit assembly is attached and fixed on the PET substrate, followed by integral hot-press encapsulating and curing the PET substrate and the acquisition circuit assembly, the acquisition and integration assembly of the battery module with flame-retardant property is obtained. The acquisition circuit assembly includes an FPC conductive circuit and a number of conductive connection busbars, the FPC conductive circuit is individually connected with each conductive connection busbar via nickel tab transition.

The flame-retardant adhesive includes 40 parts (in terms of solid content) of modified acrylic resin, 20 parts (in terms of solid content) of bisphenol A epoxy resin (E-44), 10 parts of curing agent 4,4′-diaminodiphenyl sulfone, and 60 parts of flame retardant aluminum diethylphosphonate. A preparation method of the flame-retardant adhesive is as follows:
(1) Terephthalic acid, ethyl isocyanatoacrylate, and catalyst dibutyltin dilaurate are added to an ethyl acetate solvent, followed by heating and stirring the mixture, and reaction. A molar ratio of terephthalic acid to ethyl isocyanatoacrylate is 1:2, and the amount of catalyst added is 0.4% by mass of the polymer monomer, the reaction is carried out at 85° C. with heating and stirring for 3 hours, to obtain a crosslinking monomer solution.
(2) The crosslinking monomer solution obtained in step (1) (in terms of crosslinking monomer content), methyl methacrylate, and butyl acrylate are mixed in a mass ratio of 0.15:1:2, then diluted with the ethyl acetate solvent to a solid content of 40%, after oxygen removal with nitrogen, the initiator azo diisobutyronitrile is added, and the mixture is heated to 75° C. to undergo copolymerization reaction for 4 hours, a modified acrylic resin solution is obtained.
(3) The modified acrylic resin solution obtained in step (2) (40 parts in terms of solid content) is mixed with bisphenol A epoxy resin (E-44, 20 parts in terms of solid content), the mixture is heated to 50° C. and reacted for 1 hour, then cooled to room temperature, subsequently, 60 parts by weight of the flame retardant aluminum diethylphosphinate and 10 parts by weight of the curing agent 4,4′-diaminodiphenyl sulfone are added and mixed uniformly, to obtain the flame-retardant adhesive.

### Comparative Embodiment 1

Compared with the embodiment 4, conventional ethylene glycol dimethacrylate (EGDMA) crosslinking agent is used in the preparation method of the flame-retardant adhesive in the Comparative embodiment 1, the preparation method of the flame-retardant adhesive is as follows:
(1) Crosslinking monomer ethylene glycol dimethacrylate (EGDMA), methyl methacrylate, and butyl acrylate are mixed in a mass ratio of 0.15:1:2, diluted with an ethyl acetate solvent to a solid content of 40%, after oxygen removal with nitrogen, the initiator azo diisobutyronitrile is added, and the mixture is heated to 75° C. to undergo copolymerization reaction for 4 hours, a modified acrylic resin solution is obtained.
(2) The modified acrylic resin solution obtained in step (1) (40 parts in terms of solid content) is mixed with bisphenol A epoxy resin (E-44, 20 parts in terms of solid content), the mixture is heated to 50° C. and reacted for 1 hour, then cooled to room temperature, subsequently, 60 parts by weight of the flame retardant aluminum diethylphosphinate and 10 parts by weight of the curing agent 4,4′-diaminodiphenyl sulfone are added and mixed uniformly, to obtain the flame-retardant adhesive.

The flame-retardant adhesives obtained from the above embodiments and the Comparative embodiment were tested for peel strength (by coating the adhesive onto a PET substrate film, followed by hot-press curing and 180° peel force testing), mechanical properties (by drying the adhesive into a film and testing its tensile strength using a universal mechanical testing machine), and heat resistance (by using the adhesive to bond two layers of fiberglass cloth, followed by hot-press curing, and placing the two layers of fiberglass cloth in a 300° C. oven for 5 minutes, to observe whether delamination or cracking occurred), the results are shown in Table 1 below.

TABLE 1

| | Peel | Tensile | |
|---|---|---|---|
| Test sample | strength | strength | Heat resistance |
| Embodiment 1 | 0.42 N/mm | 32 MPa | No delamination or cracking |
| Embodiment 2 | 0.58 N/mm | 19 MPa | No delamination or cracking |
| Embodiment 3 | 0.64 N/mm | 26 MPa | No delamination or cracking |
| Embodiment 4 | 0.85 N/mm | 41 MPa | No delamination or cracking |
| Comparative | 0.59 N/mm | 38 MPa | No delamination or cracking |
| embodiment 1 | | | |

It can be seen that, from the results in Table 1, the flame-retardant adhesive used in the present disclosure all exhibit good heat resistance, and can achieve excellent bonding and fixation under high-temperature conditions. A comparison result between Embodiment 1 and Embodiment 2 indicates that, compared with using epoxy resin alone, when the mixture of acrylic resin and epoxy resin is used in the flame-retardant adhesive resin, the bonding strength to the PET substrate film is significantly increased, although the tensile strength of the adhesive film decreases. The comparison result between Embodiment 2 and Embodiment 3 indicates that, when the grafting reaction is carried out between the acrylic segments in epoxy resin and acrylic resin, both the adhesive force of the adhesive layer to the PET substrate film and the tensile strength of the adhesive film are increased. A comparison result between Embodiment 3 and Embodiment 4 indicates that, by further introducing the crosslinking monomer obtained from the reaction of terephthalic acid and isocyanate ethyl acrylate, the bonding force of the adhesive layer to the PET substrate film is significantly increased, and the tensile strength of the adhesive film is significantly increased, the hot-press encapsulation effect of the acquisition circuit assembly is further improved, the high-temperature resistant and flame-retardant effect of the acquisition circuit assembly is improved, and the safety of the battery module is improved. A comparison result between Embodiment 4 and Comparative Embodiment 1 indicates that, compared with the adhesive prepared with the conventional crosslinking monomer, when the flame-retardant adhesive is prepared using the modified acrylic resin prepared by the crosslinking monomer of the present disclosure, the bonding strength of the flame-retardant adhesive to the PET substrate film is significantly increased.

The above embodiments represent preferred implementations of the present disclosure, however, the implementations of the present disclosure are not limited by these embodiments, any modifications, variations, substitutions, combinations, or simplifications made without departing from the substantive spirit and principles of the present disclosure shall be construed as equivalent replacement methods and shall fall within the scope of protection of the present disclosure.

What is claimed is:

1. An acquisition and integration assembly of a battery module with flame-retardant property, comprising:
a PET substrate film coated with a flame-retardant adhesive layer; and
an acquisition circuit assembly hot-press encapsulated on one side of the flame-retardant adhesive layer of the PET substrate film;
wherein the flame-retardant adhesive layer comprises following components in parts by weight: 20 to 80 parts of a thermally curable resin, 5 to 20 parts of a curing agent, and 20 to 80 parts of a flame retardant.

2. The acquisition and integration assembly of the battery module with flame-retardant property according to claim 1, wherein a thickness of the PET substrate film is 0.03 to 0.5 mm, and a thickness of the flame-retardant adhesive layer is 0.1 to 1 mm.

3. The acquisition and integration assembly of the battery module with flame-retardant property according to claim 1, wherein the acquisition circuit assembly comprises a conductive circuit and a plurality of conductive connection busbars connected with the conductive circuit; wherein the conductive circuit is an FPC, and the FPC is individually connected with each of the plurality of conductive connection busbars via a nickel tab; or the conductive circuit is an FFC, and the FFC is individually connected with each of the plurality of conductive connection busbars via the nickel tab; or the conductive circuit is an FDC, and the FDC is individually connected with each of the plurality of conductive connection busbars via the nickel tab, or the FDC is directly connected with each of the plurality of conductive connection busbars; or the conductive circuit is an FCC, the FCC is formed by utilizing the FFC to be individually connected with each of the plurality of conductive connection busbars via an FPC sub-board.

4. The acquisition and integration assembly of the battery module with flame-retardant property according to claim 1, wherein the thermally curable resin is at least one of nitrile rubber, epoxy resin, polyester resin, acrylic resin, and polyurethane resin; the curing agent is at least one of 4,4′-diaminodiphenyl sulfone, dicyandiamide, acid anhydride, imidazole, HDI, TDI, and melamine; and the flame retardant is at least one of aluminum diethylphosphonate, hexaphenoxycyclotriphosphazene, and ammonium polyphosphate.

5. The acquisition and integration assembly of the battery module with flame-retardant property according to claim 1, wherein a mica sheet, mica paper, flexible ceramic, fire-resistant paper, aerogel, or ceramic sheet flame-retardant sheet layer is additionally arranged between the PET substrate film and the acquisition circuit assembly; wherein a flame-retardant adhesive layer is coated between the flame-retardant sheet layer and the acquisition circuit assembly, and between the flame-retardant sheet layer and the PET substrate film.

6. The acquisition and integration assembly of the battery module with flame-retardant property according to claim 1, wherein the acquisition circuit assembly is provided with or without an opening at a location corresponding to a battery cell explosion-proof valve; when the opening is provided, a flame-retardant adhesive layer is or is not provided on a side of the acquisition circuit assembly facing a battery cell; when no opening is provided, the flame-retardant adhesive layer is provided on the side of the acquisition circuit assembly facing the battery cell.

7. A preparation method of preparing an acquisition and integration assembly of a battery module with flame-retardant property, comprising following preparation steps:
(1) adding terephthalic acid, ethyl isocyanatoacrylate, and an organotin catalyst to an ethyl acetate solvent, heating and stirring to react, and obtaining a crosslinking monomer solution;
(2) mixing the crosslinking monomer solution obtained in step (1) with an acrylic acid monomer and an acrylate monomer, diluting with the ethyl acetate solvent, removing oxygen with nitrogen, adding an initiator, heating to undergo copolymerization reaction, and obtaining a modified acrylic resin solution;
(3) mixing the modified acrylic resin solution obtained in step (2) with an epoxy resin, heating to react, cooling to room temperature, adding a flame retardant and a curing agent, and mixing uniformly to obtain a mixed adhesive solution;
(4) coating the mixed adhesive solution obtained in step (3) onto a PET substrate film, attaching and fixing the acquisition circuit assembly, integral hot-press encapsulating and curing the PET substrate film and the acquisition circuit assembly, and obtaining the acquisition and integration assembly of the battery module with flame-retardant property.

8. The preparation method of preparing the acquisition and integration assembly of the battery module with flame-retardant property according to claim 7, wherein, in step (1), a molar ratio of the terephthalic acid to the ethyl isocyanatoacrylate is 1:2; the organotin catalyst is dibutyltin dilaurate; and a temperature range for heating and stirring to react is 60 to 90° C.

9. The preparation method of preparing the acquisition and integration assembly of the battery module with flame-retardant property according to claim 7, wherein, in step (2), the acrylic acid monomer is one or a mixture of acrylic acid and methacrylic acid; and the acrylate monomer is at least one of methyl acrylate, methyl methacrylate, ethyl acrylate, ethyl methacrylate, hydroxyethyl acrylate, hydroxyethyl methacrylate, hydroxypropyl methacrylate, hydroxybutyl methacrylate, butyl acrylate, butyl methacrylate, 2-ethylhexyl acrylate, and 2-ethylhexyl methacrylate.

10. The preparation method of preparing the acquisition and integration assembly of the battery module with flame-retardant property according to claim 7, wherein, in step (2), a mass ratio of the crosslinking monomer contained in the crosslinking monomer solution to the acrylic acid monomer and the acrylate monomer is 0.05 to 0.3:1 to 2:1 to 2.

11. The preparation method of preparing the acquisition and integration assembly of the battery module with flame-retardant property according to claim 7, wherein, in step (2), an amount of the ethyl acetate solvent added for dilution results in a solid content of a reaction system of 30% to 50%; the initiator is azobisisobutyronitrile or azobisisovaleronitrile; and a temperature range for the copolymerization reaction is 60 to 80° C.

12. The preparation method of preparing the acquisition and integration assembly of the battery module with flame-retardant property according to claim 7, wherein, in step (3), the epoxy resin is a bisphenol A epoxy resin or a bisphenol F epoxy resin; and a mass ratio of the modified acrylic resin contained in the modified acrylic resin solution to the epoxy resin is 2 to 4:1 to 2.

13. The preparation method of preparing the acquisition and integration assembly of the battery module with flame-retardant property according to claim 7, wherein, in step (3), a temperature range for a heating reaction is 40 to 60° C., a duration range for the heating reaction is 0.5 to 3 hours.

14. The preparation method of preparing the acquisition and integration assembly of the battery module with flame-retardant property according to claim 7, wherein, in step (4), the mixed adhesive solution is coated onto the PET substrate film using a roll-to-roll process.
